(19) United States
(12) Patent Application Publication
(10) Pub. No.: US 2022/0384869 A1
(43) Pub. Date: Dec. 1, 2022

(54) BATTERY MODULE WITH AN ABILITY OF HOMOGENIZING TEMPERATURES

(71) Applicant: Cheng Uei Precision Industry Co., Ltd., New Taipei City (TW)

(72) Inventors: Ta Chang Yang, New Taipei City (TW); Min Yu Wu, New Taipei City (TW)

(21) Appl. No.: 17/474,319

(22) Filed: Sep. 14, 2021

(30) Foreign Application Priority Data
May 31, 2021 (CN) 202121199687.8

(51) Int. Cl. H01M 10/617; H01M 50/204; H01M 10/653; H01M 50/227; H01M 50/224; H01M 50/284; H01M 10/48; H01M 10/6551

(52) U.S. Cl. CPC H01M 10/617; H01M 50/204; H01M 10/653; H01M 50/227; H01M 50/224; H01M 50/284; H01M 10/48; H01M 10/6551

(57) ABSTRACT

A battery module with an ability of homogenizing temperatures includes at least one battery pack and at least one temperature homogenizing element. The at least one battery pack includes a plurality of batteries. The plurality of the batteries are divided into a middle group of the batteries and an outer group of the batteries. The outer group of the batteries surround the middle group of the batteries. The at least one temperature homogenizing element is mounted around the middle group of the batteries. The at least one temperature homogenizing element has a plurality of fixing holes. The middle group of the batteries are inserted into the plurality of the fixing holes, and the outer group of the batteries are attached to an outer surface of an outer wall of the at least one temperature homogenizing element.

### CROSS-REFERENCE TO RELATED APPLICATION

The present application is based on, and claims priority from, China Patent Application No. 202121199687.8, filed May 31, 2021, the disclosure of which is hereby incorporated by reference herein in its entirety.

### BACKGROUND OF THE INVENTION

### 1. Field of the Invention

The present invention generally relates to a battery module, and more particularly to a battery module with an ability of homogenizing temperatures.

### 2. The Related Art

Generally, a battery pack includes a plurality of batteries, when the battery pack is used, each battery will heat up due to a discharge of each battery. However, the discharge and a temperature rise of each battery are different, and the plurality of the batteries are closely arranged together, the temperature rise of each battery will affect other batteries around the battery which has the temperature rise.

If the temperature rise of one battery is higher, temperatures of the batteries around the one battery rise, and the temperatures of several batteries of the battery pack are overly high, in that case, a temperature distribution in the battery pack is uneven, and temperatures of other batteries around the several batteries will be overly high, consequently, the battery pack is easily damaged. Moreover, if the temperature distribution in the battery pack is uneven, a part of the battery pack with a higher temperature will require more time for heat dissipation, and correspondingly, an overall heat dissipation efficiency of the battery pack is lowered.

Therefore, it is necessary to provide a battery module with an ability of homogenizing temperatures to make a temperature distribution in the battery module with the ability of homogenizing temperatures homogenized, so that the battery module with the ability of homogenizing temperatures is prevented from being damaged due to some overheated batteries of the battery module with the ability of homogenizing temperatures.

### SUMMARY OF THE INVENTION

An object of the present invention is to provide a battery module with an ability of homogenizing temperatures. The battery module with the ability of homogenizing temperatures includes at least one battery pack and at least one temperature homogenizing element. The at least one battery pack includes a plurality of batteries. The plurality of the batteries are divided into a middle group of the batteries and an outer group of the batteries. The middle group of the batteries are located in a middle of the at least one battery pack. The outer group of the batteries surround the middle group of the batteries. The at least one temperature homogenizing element is mounted around the middle group of the batteries. The at least one temperature homogenizing element has a plurality of fixing holes. Inner surfaces of peripheral walls of the plurality of the fixing holes are sprinkled with talcum powder. The middle group of the batteries are inserted into the plurality of the fixing holes, and the outer group of the batteries are attached to an outer surface of an outer wall of the at least one temperature homogenizing element.

Another object of the present invention is to provide a battery module with an ability of homogenizing temperatures. The battery module with the ability of homogenizing temperatures includes two battery packs and a housing. Each battery pack includes a frame, a plurality of batteries, a temperature homogenizing element and two heat conducting elements. The plurality of the batteries are mounted in the frame. A positive electrode and a negative electrode of each battery are exposed outside from two opposite side walls of the frame, respectively. The plurality of the batteries are divided into a middle group of the batteries and an outer group of the batteries. The middle group of the batteries are located in a middle of the at least one battery pack. The outer group of the batteries surround the middle group of the batteries. The temperature homogenizing element is mounted around the middle group of the batteries. The temperature homogenizing element has a plurality of fixing holes. The middle group of the batteries are inserted into the plurality of the fixing holes, and the outer group of the batteries are attached to an outer surface of an outer wall of the temperature homogenizing element. The two heat conducting elements are attached to two outer surfaces of the two opposite side walls of the frame. One side surface of each heat conducting element is in contact with the positive electrode or the negative electrode of each battery. The housing surrounds the frame. The other side surface of each heat conducting element is in contact with an inner surface of the housing. In order to make the plurality of the batteries easily assembled to the at least one temperature homogenizing element in place, before the plurality of the batteries are assembled with the at least one temperature homogenizing element, the at least one temperature homogenizing element are sprinkled with talcum powder.

Another object of the present invention is to provide a battery module with an ability of homogenizing temperatures. The battery module with the ability of homogenizing temperatures includes at least one temperature homogenizing element, a plurality of batteries and a circuit board. The at least one temperature homogenizing element has a plurality of fixing holes. Peripheral walls of the plurality of the fixing holes are sprinkled with talcum powder. The plurality of batteries are partially inserted into the plurality of the fixing holes of the at least one temperature homogenizing element, and the plurality of the batteries are partially attached to an outer surface of an outer wall of the at least one temperature homogenizing element. The circuit board is equipped with a battery management system for measuring voltages of the plurality of the batteries.

As described above, the battery module with the ability of homogenizing temperatures homogenizes temperatures of the plurality of the batteries of each battery pack by the temperature homogenizing element of each battery pack. In this way, a temperature distribution of each battery pack is homogenized, so that each battery pack of the battery module with the ability of homogenizing temperatures is prevented from being damaged due to an excessive temperature and some overheated batteries of the battery module with the ability of homogenizing temperatures.

### BRIEF DESCRIPTION OF THE DRAWINGS

The present invention will be apparent to those skilled in the art by reading the following description, with reference to the attached drawings, in which:

FIG. 1 is a perspective view of a battery module with an ability of homogenizing temperatures according to the present invention;

FIG. 2 is a partially exploded view of the battery module with the ability of homogenizing temperatures of FIG. 1;

FIG. 3 is an exploded perspective view of a battery pack of the battery module with the ability of homogenizing temperatures of FIG. 2;

FIG. 4 is a perspective view of a temperature homogenizing element of the battery module with the ability of homogenizing temperatures of FIG. 3;

FIG. 5 is a top view showing that the temperature homogenizing element is mounted to a plurality of batteries of the battery module with the ability of homogenizing temperatures of FIG. 3; and

FIG. 6 is a sectional view of the battery module with the ability of homogenizing temperatures along a line VI-VI of FIG. 1.

### DETAILED DESCRIPTION OF THE PREFERRED EMBODIMENT

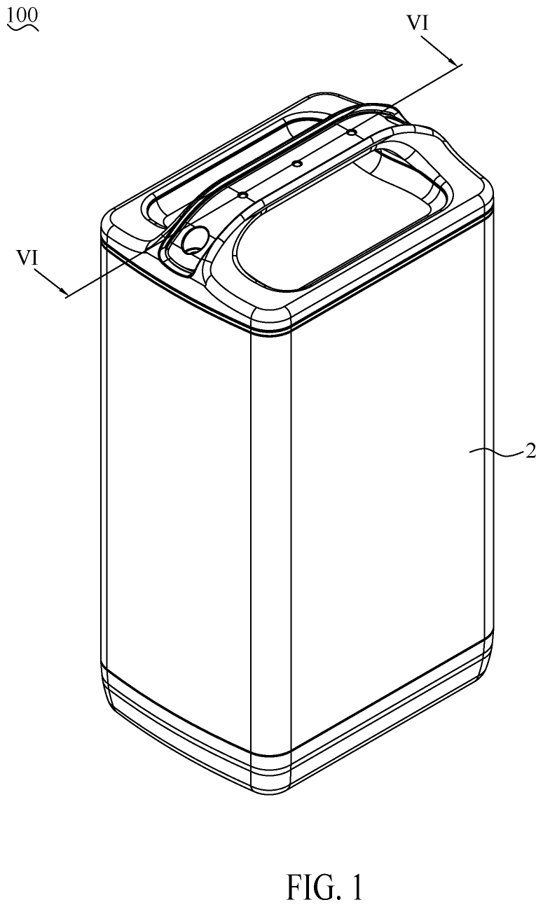

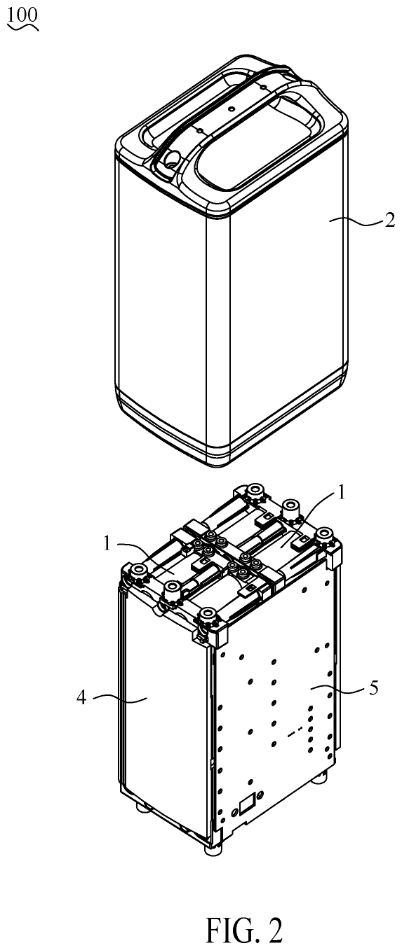

With reference to FIG. 1 and FIG. 2, a battery module with an ability of homogenizing temperatures 100 according to the present invention is shown. The battery module with the ability of homogenizing temperatures 100 includes at least one battery pack 1, a housing 2 and a circuit board 5. The at least one battery pack 1 is mounted in the housing 2.

Referring to FIG. 1 to FIG. 3, the at least one battery pack 1 includes a plurality of batteries 11 and a frame 12. Specifically, the battery module with the ability of homogenizing temperatures 100 includes two battery packs 1. Each battery pack 1 includes the plurality of the batteries 11 and the frame 12. The plurality of the batteries 11 are mounted in the frame 12, and the plurality of the batteries 11 are arranged in a stagger honeycomb arrangement. A positive electrode and a negative electrode of each battery 11 are exposed outside from two opposite side walls of the frame 12, respectively. The frame 12 is made of plastic. The housing 2 surrounds the frame 12, and the housing 2 is made of a metal. The housing 2 is made of aluminum. Specifically, the housing 2 is made by an aluminum extrusion technology.

The plurality of the batteries 11 are divided into a middle group of the batteries 11 and an outer group of the batteries 11. The middle group of the batteries 11 are located in a middle of the at least one battery pack 1. The outer group of the batteries 11 surround the middle group of the batteries 11.

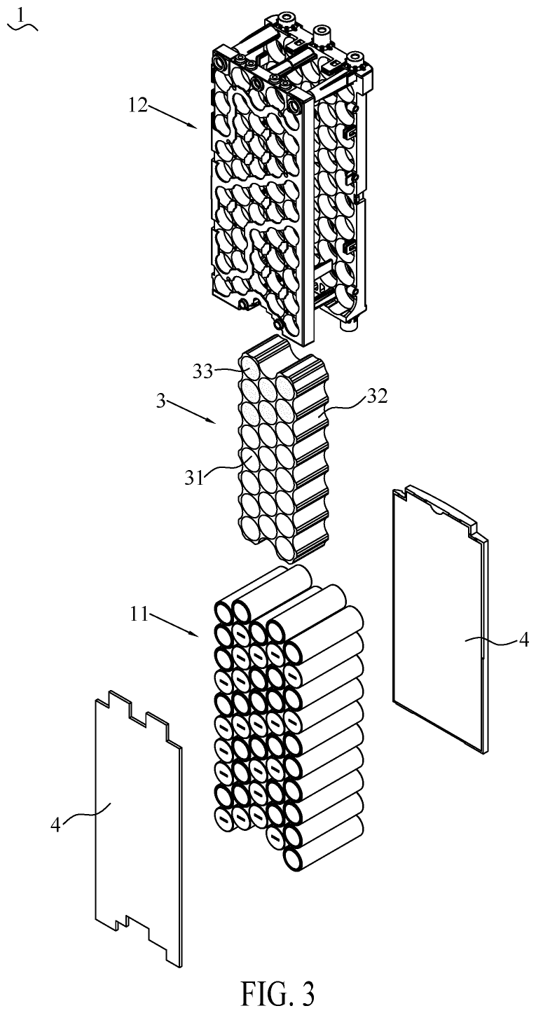

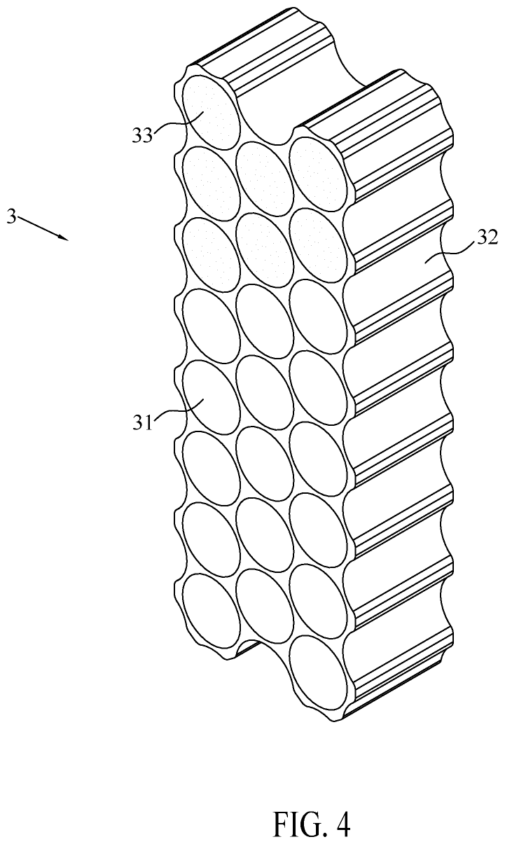

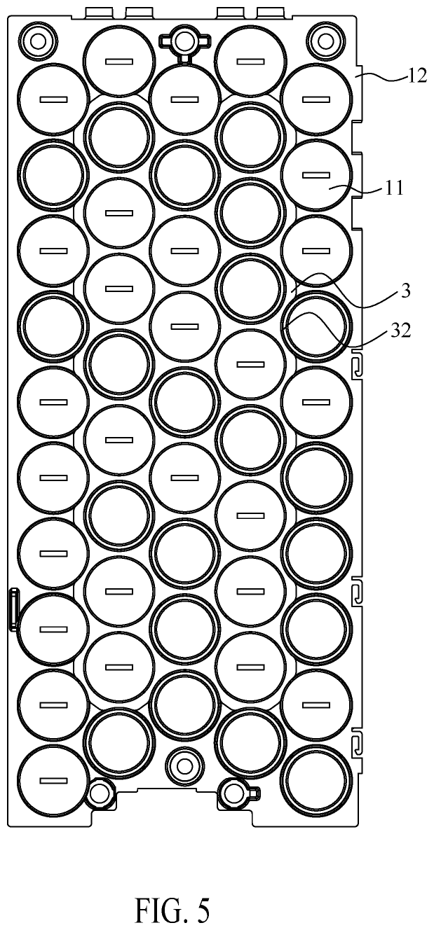

With reference to FIG. 3 to FIG. 6, the at least one battery pack 1 further includes at least one temperature homogenizing element 3 and at least one heat conducting element 4. The at least one temperature homogenizing element 3 is mounted around the middle group of the batteries 11. The at least one temperature homogenizing element 3 has a plurality of fixing holes 31. Inner surfaces of peripheral walls of the plurality of the fixing holes 31 are sprinkled with talcum powder 33. The plurality of the batteries 11 and the at least one temperature homogenizing element 3 are mounted in the frame 12. The plurality of the batteries 11 are partially inserted into the plurality of the fixing holes 31 of the at least one temperature homogenizing element 3, and the plurality of the batteries 11 are partially attached to an outer surface of an outer wall 32 of the at least one temperature homogenizing element 3. Specifically, each battery pack 1 further includes a temperature homogenizing element 3 and two heat conducting elements 4. The temperature homogenizing element 3 of each battery pack 1 is mounted around the middle group of the batteries 11. The outer group of the batteries 11 are attached to the outer surface of the outer wall 32 of the at least one temperature homogenizing element 3, and the outer group of the batteries 11 contact with the outer surface of the outer wall 32 of the at least one temperature homogenizing element 3.

In order to make the plurality of the batteries 11 easily assembled to the at least one temperature homogenizing element 3 in place, before the plurality of the batteries 11 are assembled with the at least one temperature homogenizing element 3, the at least one temperature homogenizing element 3 are sprinkled with the talcum powder 33, so that the plurality of the batteries 11 are inserted into the fixing holes 31 of the at least one temperature homogenizing element 3 smoothly, and the at least one temperature homogenizing element 3 is attached to the plurality of the batteries 11 tightly and completely, an optimum contacting area between the plurality of the batteries 11 and the at least one temperature homogenizing element 3 which has a homogenized temperature is reached, and the optimum contacting area between the plurality of the batteries 11 and the at least one temperature homogenizing element 3 is beneficial for a heat dissipation of each battery pack 1. Thus, when the plurality of the batteries 11 are mounted to the at least one temperature homogenizing element 3, a phenomenon that the at least one temperature homogenizing element 3 is closely attached to the plurality of the batteries 11 in advance is prevented, and a phenomenon that the plurality of the batteries 11 are difficult to be assembled to the at least one temperature homogenizing element 3 in place is prevented.

Specifically, the outer group of the batteries 11 are attached to the outer surface of the outer wall 32 of the temperature homogenizing element 3 of each battery pack 1, and the outer group of the batteries 11 contact with the outer surface of the outer wall 32 of the temperature homogenizing element 3 of each battery pack 1. The temperature homogenizing element 3 has the plurality of fixing holes 31. The plurality of the fixing holes 31 longitudinally penetrate through a front surface and a rear surface of the temperature homogenizing element 3. The plurality of the fixing holes 31 are arranged in the stagger honeycomb arrangement. The middle group of the batteries 11 are inserted into the plurality of the fixing holes 31. Side walls of the plurality of the fixing holes 31 surround the middle group of the batteries 11.

The outer wall 32 of the at least one temperature homogenizing element 3 is in a wavy shape. Because each battery 11 is in a cylindrical shape, the wavy outer wall 32 increases a contact area between the outer wall 32 and outer surfaces of the outer group of the cylindrical batteries 11 to improve a heat conduction effect.

The at least one heat conducting element 4 is attached to an outer surface of at least one side wall of the frame 12. One side surface of the at least one heat conducting element 4 is towards the plurality of the batteries 11 of the at least one battery pack 1, and the one side surface of the at least one heat conducting element 4 is in contact with the positive electrode or the negative electrode of each battery 11 which is exposed from the frame 12 of the at least one battery pack 1. The other side surface of the at least one heat conducting element 4 is in contact with an inner surface of the housing 2 of the battery module with the ability of homogenizing temperatures 100.

Specifically, the two heat conducting elements 4 of each battery pack 1 are attached to two outer surfaces of the two opposite side walls of the frame 12 of each battery pack 1. When each battery pack 1 is in assembly, one side surface of each heat conducting element 4 is towards the plurality of the batteries 11, and the one side surface of each heat conducting element 4 is in contact with the positive electrode or the negative electrode of each battery 11 which is exposed from the frame 12. The other side surface of each heat conducting element 4 is in contact with the inner surface of the housing 2.

The at least one temperature homogenizing element 3 and the at least one heat conducting element 4 are made of a liquid silicone rubber material with a heat conducting function. The temperature homogenizing element 3 and each heat conducting element 4 are made of the liquid silicone rubber material. The temperature homogenizing element 3 and each heat conducting element 4 are molded by way of an injection molding of the liquid silicone rubber (LSR) material. The liquid silicone rubber material is a soft thermosetting material. The soft thermosetting material has a non-toxic characteristic, a high temperature resistance characteristic, a high resilience characteristic. The soft thermosetting material is a unique soft elastomer material, and a molecular composition of the soft thermosetting material has both of an inorganic molecule structure and an organic molecule structure.

A rheology performance of the liquid silicone rubber material is mainly shown as a low viscosity, a high fluidity, fast curing, shear thinning and a high thermal expansion coefficient. The liquid silicone rubber material is able to be applied in mass production, and the liquid silicone rubber material is able to be molded to a product by way of the injection molding. In the present invention, the product is the temperature homogenizing element 3 or the heat conducting element 4 of each battery pack 1. The product is shown as a better high temperature resistance characteristic, a better low temperature resistance characteristic, a better thermal stability characteristic, an excellent electrical insulation characteristic, a mechanical characteristic, a chemical resistance characteristic, an abrasion resistance characteristic, an ozone resistance characteristic, and an excellent color stability. The liquid silicone rubber material is able to block water, and the liquid silicone rubber material is able to form a waterproof seal. The liquid silicone rubber material has a fireproof performance and a fire resistance performance, even if the liquid silicone rubber material is burnt, the liquid silicone rubber material is without toxic substances. The liquid silicone rubber material is extremely clean. The liquid silicone rubber material is free of impurities and any potential biology pollutants. The liquid silicone rubber material conforms to a medical grade and a food grade, etc.

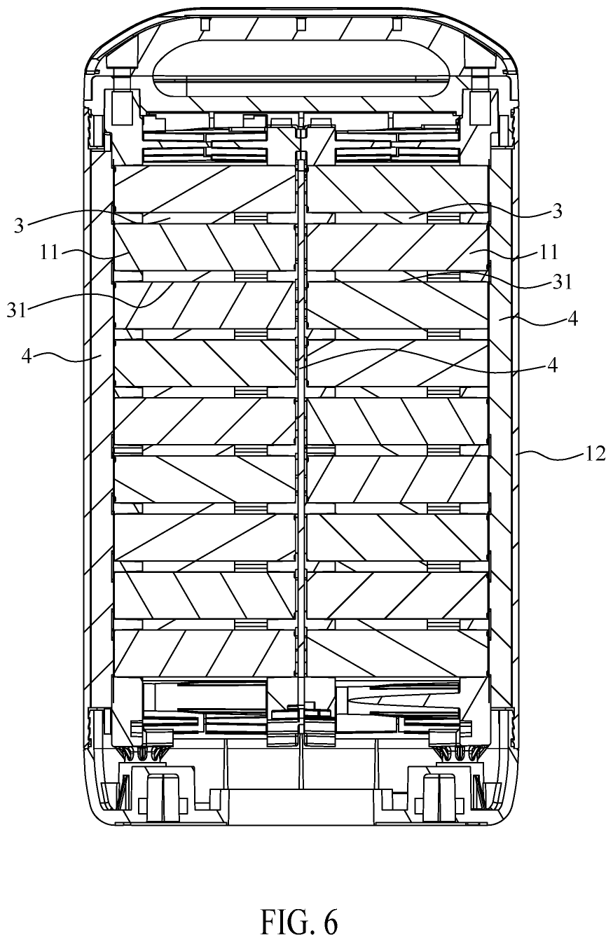

With reference to FIG. 2 and FIG. 6, when the battery module with the ability of homogenizing temperatures 100 includes the housing 2, a plurality of the battery packs 1 and a plurality of the heat conducting elements 4. Each battery pack 1 includes the frame 12, the at least one heat conducting element 4, and the at least one heat conducting element 4 is mounted to each battery pack 1.

The at least one heat conducting element 4 is attached to the outer surface of the at least one side wall of the frame 12. The one side surface of the at least one heat conducting element 4 is towards the plurality of the batteries 11 of each battery pack 1, and the one side surface of the at least one heat conducting element 4 is in contact with the positive electrode or the negative electrode of each battery 11 which is exposed from the frame 12 of each battery pack 1.

An outer surface of the plurality of the battery packs 1 is equipped with at least another heat conducting element 4. One side surface of the at least another heat conducting element 4 contacts with the positive electrode or the negative electrode of each battery 11 which is exposed from the frame 12. The other side surface of each heat conducting element 4 is in contact with the inner surface of the housing 2 of the battery module with the ability of homogenizing temperatures 100.

Referring to FIG. 1 to FIG. 6, when the battery module with the ability of homogenizing temperatures 100 is in operation, the plurality of the batteries 11 will continue heating up. Because temperature rising conditions of the plurality of the batteries 11 are different, a rising temperature of each battery 11 will be transmitted to the temperature homogenizing element 3 of each battery pack 1. The temperature homogenizing element 3 of each battery pack 1 homogenizes the rising temperatures of the plurality of the batteries 11 of each battery pack 1, so that the temperature rising conditions of the plurality of the batteries 11 is tended to be consistent, and a temperature distribution in each battery pack 1 is homogenized so as to avoid that a partial region of each battery pack 1 has a higher temperature situation. The rising temperature of each battery 11 is simultaneously conducted to the heat conducting element 4 of each battery pack 1 which is arranged outside the frame 12 and is in contact with the positive electrode or the negative electrode of each battery 11 exposed outside from the frame 12, and the heat conducting element 4 conducts heat to the housing 2, so that the battery module with the ability of homogenizing temperatures 100 reaches an optimum temperature homogenizing effect and an optimum heat conducting effect. The housing 2 has a better heat dissipation performance, so that each battery pack 1 proceeds with the heat dissipation to prevent each battery pack 1 from being damaged due to excessive temperature.

The circuit board 5 of the battery module with the ability of homogenizing temperatures 100 is equipped with a battery management system (BMS) for measuring voltages of the plurality of the batteries 11, so that abnormal conditions of the battery module with the ability of homogenizing temperatures 100 are prevented from being caused on account of the battery management system. The abnormal conditions of the battery module with the ability of homogenizing temperatures 100 include an over-discharge condition of the plurality of the batteries 11, an over-charge condition of the plurality of the batteries 11 and an over-temperature condition of the plurality of the batteries 11.

As described above, the battery module with the ability of homogenizing temperatures 100 homogenizes temperatures of the plurality of the batteries 11 of each battery pack 1 by the temperature homogenizing element 3 of each battery pack 1. In this way, the temperature distribution of each battery pack 1 is homogenized, so that each battery pack 1 of the battery module with the ability of homogenizing temperatures 100 is prevented from being damaged due to the excessive temperature and some overheated batteries 11 of the battery module with the ability of homogenizing temperatures 100.

What is claimed is:

1. A battery module with an ability of homogenizing temperatures, comprising:
at least one battery pack including a plurality of batteries, the plurality of the batteries being divided into a middle group of the batteries and an outer group of the batteries, the middle group of the batteries being located in a middle of the at least one battery pack, the outer group of the batteries surrounding the middle group of the batteries; and
at least one temperature homogenizing element mounted around the middle group of the batteries, the at least one temperature homogenizing element having a plurality of fixing holes, inner surfaces of peripheral walls of the plurality of the fixing holes being sprinkled with talcum powder, the middle group of the batteries being inserted into the plurality of the fixing holes, and the outer group of the batteries being attached to an outer surface of an outer wall of the at least one temperature homogenizing element.

2. The battery module with the ability of homogenizing temperatures as claimed in claim 1, wherein the plurality of the batteries are arranged in a stagger honeycomb arrangement, the plurality of the fixing holes are arranged in the stagger honeycomb arrangement.

3. The battery module with the ability of homogenizing temperatures as claimed in claim 1, wherein the outer wall of the at least one temperature homogenizing element is in a wavy shape.

4. The battery module with the ability of homogenizing temperatures as claimed in claim 1, wherein the at least one temperature homogenizing element is made of a liquid silicone rubber material with a heat conducting function.

5. The battery module with the ability of homogenizing temperatures as claimed in claim 1, further comprising a housing, the at least one battery pack further including a frame and at least one heat conducting element, the plurality of the batteries and the at least one temperature homogenizing element being mounted in the frame, a positive electrode and a negative electrode of each battery being exposed outside from two opposite sides of the frame, the at least one heat conducting element being attached to an outer surface of at least one side wall of the frame, one side surface of the at least one heat conducting element being in contact with the positive electrode or the negative electrode of each battery exposed from the frame, and the other side surface of the at least one heat conducting element being in contact with an inner surface of the housing of the battery module with the ability of homogenizing temperatures.

6. The battery module with the ability of homogenizing temperatures as claimed in claim 5, wherein the frame is made of plastic.

7. The battery module with the ability of homogenizing temperatures as claimed in claim 5, wherein the housing is made of aluminum.

8. The battery module with the ability of homogenizing temperatures as claimed in claim 5, wherein the at least one heat conducting element is made of a liquid silicone rubber material with a heat conducting function.

9. The battery module with the ability of homogenizing temperatures as claimed in claim 5, wherein when the battery module with the ability of homogenizing temperatures includes a housing, a plurality of battery packs and a plurality of heat conducting elements, each battery pack includes a frame and at least one heat conducting element, the at least one heat conducting element is mounted to each battery pack, an outer surface of the plurality of the battery packs are equipped with at least another heat conducting element, the at least another heat conducting element contacts with a positive electrode or a negative electrode of each battery which is exposed from the frame, each heat conducting element is in contact with the housing.

10. The battery module with the ability of homogenizing temperatures as claimed in claim 1, wherein in order to make the plurality of the batteries easily assembled to the at least one temperature homogenizing element in place, before the plurality of the batteries are assembled with the at least one temperature homogenizing element, the at least one temperature homogenizing element are sprinkled with the talcum powder.

11. The battery module with the ability of homogenizing temperatures as claimed in claim 1, further comprising a circuit board, the circuit board being equipped with a battery management system for measuring voltages of the plurality of the batteries.

12. A battery module with an ability of homogenizing temperatures, comprising:
two battery packs, each battery pack including
a frame,
a plurality of batteries mounted in the frame, a positive electrode and a negative electrode of each battery being exposed outside from two opposite side walls of the frame, respectively, the plurality of the batteries being divided into a middle group of the batteries and an outer group of the batteries, the middle group of the batteries being located in a middle of the at least one battery pack, the outer group of the batteries surrounding the middle group of the batteries,
a temperature homogenizing element mounted around the middle group of the batteries, the temperature homogenizing element having a plurality of fixing holes, the middle group of the batteries being inserted into the plurality of the fixing holes, and the outer group of the batteries being attached to an outer surface of an outer wall of the temperature homogenizing element, and
two heat conducting elements being attached to two outer surfaces of the two opposite side walls of the frame, one side surface of each heat conducting element being in contact with the positive electrode or the negative electrode of each battery; and
a housing surrounding the frame, the other side surface of each heat conducting element being in contact with an inner surface of the housing,
wherein in order to make the plurality of the batteries easily assembled to the at least one temperature homogenizing element in place, before the plurality of the batteries are assembled with the at least one temperature homogenizing element,
the at least one temperature homogenizing element are sprinkled with talcum powder.

13. A battery module with an ability of homogenizing temperatures, comprising:
at least one temperature homogenizing element having a plurality of fixing holes, peripheral walls of the plurality of the fixing holes being sprinkled with talcum powder;
a plurality of batteries being partially inserted into the plurality of the fixing holes of the at least one temperature homogenizing element, and the plurality of the batteries being partially attached to an outer surface of an outer wall of the at least one temperature homogenizing element; and
a circuit board equipped with a battery management system for measuring voltages of the plurality of the batteries.

14. The battery module with the ability of homogenizing temperatures as claimed in claim 13, further comprising a frame, the plurality of the batteries being mounted in the frame, a positive electrode and a negative electrode of each battery being exposed outside from two opposite side walls of the frame, respectively.

15. The battery module with the ability of homogenizing temperatures as claimed in claim 14, further comprising two heat conducting elements and a housing, the two heat conducting elements being attached to two outer surfaces of the two opposite side walls of the frame, one side surface of each heat conducting element being towards the plurality of the batteries, and the one side surface of each heat conducting element being in contact with the positive electrode or the negative electrode of each battery which is exposed from the frame, the housing surrounding the frame, the other side surface of each heat conducting element being in contact with an inner surface of the housing.

16. The battery module with the ability of homogenizing temperatures as claimed in claim 13, wherein abnormal conditions of the battery module with the ability of homogenizing temperatures are prevented from being caused on account of the battery management system, the abnormal conditions of the battery module with the ability of homogenizing temperatures include an over-discharge condition of the plurality of the batteries, an over-charge condition of the plurality of the batteries and an over-temperature condition of the plurality of the batteries.
